(19) United States
(12) Patent Application Publication
(10) Pub. No.: US 2026/0131611 A1
(43) Pub. Date: May 14, 2026

(54) SPRING RECEPTACLE, VIBRATION DAMPER, AND METHOD

(71) Applicants: thyssenkrupp Bilstein GmbH, Ennepetal (DE); thyssenkrupp AG, Essen (DE)

(72) Inventors: Jens ROBRECHT, Nettersheim (DE); Martin FLICK, Gummersbach (DE)

(73) Assignees: thyssenkrupp Bilstein GmbH, Ennepetal (DE); thyssenkrupp AG, Essen (DE)

(21) Appl. No.: 19/384,983

(22) Filed: Nov. 10, 2025

(30) Foreign Application Priority Data
Nov. 11, 2024 (DE) 10 2024 132 755.3

(51) Int. Cl. B60G 15/06

(52) U.S. Cl. CPC B60G 15/063; B60G 2202/312; B60G 2204/1242; B60G 2500/30

(57) ABSTRACT

A spring receptacle, in particular spring plate, for a vibration damper comprises at least one spring receptacle ring, which in the installed state is arranged on an outer tube of the vibration damper, and at least one adjusting device, which is designed to change or fix the position of the spring receptacle ring along the longitudinal axis of the vibration damper, wherein the adjusting device comprises at least one blocking body and at least one actuating element which preloads the blocking body in the direction of a receiving region of the outer tube and is movable between at least one locking position and at least one release position, wherein the blocking body lies at least partially against the spring receptacle ring in the locking position in such a way that a form fit is formed between the blocking body and the receiving region in the circumferential direction of the outer tube.

### CROSS REFERENCE TO RELATED APPLICATION

This application is a U.S. Non-Provisional that claims priority to German Patent Application No. DE 10 2024 132 755.3, filed Nov. 11, 2024, the entire content of which is incorporated herein by reference.

### FIELD

The present disclosure relates to a spring receptacle, in particular a spring plate, for a vibration damper.

### BACKGROUND

The invention further relates to a vibration damper comprising at least one spring receptacle and to a method for adjusting the position of such a spring receptacle along the longitudinal axis of the vibration damper.

Vibration dampers are commonly used for motor vehicles and in the industrial sector to ensure safe and comfortable driving behaviour of a vehicle in different driving conditions caused by irregularities such as bumps, potholes or other road surface anomalies. Vibration dampers also serve to stabilize vehicles when travelling in more extreme conditions, for example when travelling off-road.

Spring receptacles, in particular spring plates, for vibration dampers are known from the prior art and usually serve to receive suspension springs, such as helical springs. The spring receptacles ensure that the suspension springs are kept under tension during use. The suspension springs can thus convert shocks caused by an uneven roadway into oscillating movements. In order to optimally perform this function, it is often necessary to change the position of the spring receptacle along the longitudinal axis of the vibration damper.

DE 10 2019 218 494 A1 discloses a spring receptacle, the position of which is variable along the longitudinal axis of the vibration damper. The known spring receptacle has a variable inner cross section in order to fix the spring receptacle by clamping on the outer circumference of the vibration damper. However, it is disadvantageous that the clamping can lead to damage to the vibration damper.

Thus a need exists for specifying a spring receptacle which enables, on the one hand, a change of the position along the longitudinal axis of a vibration damper and, on the other hand, fixing on the vibration damper, without causing damage to the vibration damper. Some embodiments include a vibration damper comprising at least one spring receptacle of this kind and a method for adjusting the position of such a spring receptacle along the longitudinal axis of the vibration damper.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a perspective view of a vibration damper comprising a spring receptacle according to one exemplary embodiment according to the invention.

FIG. 2 shows a longitudinal section of the vibration damper according to FIG. 1.

FIG. 3 shows an enlarged detail of the spring receptacle according to FIG. 2 with a spring receptacle ring and an adjusting device.

FIG. 4 shows an enlarged detail of the adjusting device according to FIG. 3.

FIG. 5 shows an enlarged detail of the spring receptacle ring according to FIG. 3.

FIG. 6 shows a perspective view of the spring receptacle according to FIG. 1.

FIG. 7 shows a perspective view of the adjusting device according to FIG. 1.

FIG. 8 shows a longitudinal section of a vibration damper according to another exemplary embodiment according to the invention.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

Some embodiments include a spring receptacle, in particular a spring plate, for a vibration damper, comprising at least one spring receptacle ring, which in the installed state is arranged on an outer tube of the vibration damper, and at least one adjusting device, which is designed to change or fix the position of the spring receptacle ring along the longitudinal axis of the vibration damper. The adjusting device comprises at least one blocking body and at least one actuating element which preloads the blocking body in the direction of a receiving region of the outer tube and is movable between at least one locking position and at least one release position. The blocking body lies at least partially against the spring receptacle ring in the locking position in such a way that a form fit is formed between the blocking body and the receiving region in the circumferential direction of the outer tube.

The invention has various advantages.

For instance, the spring receptacle according to the invention enables an adjustment of the spring receptacle ring along the longitudinal axis of the outer tube of the vibration damper. To this end, the spring receptacle comprises an adjusting device comprising an actuating element and a blocking body. The actuating element is movable between a locking position and a release position, in order to block or release the blocking body. The actuating element may, for example, be a grub screw. Other configurations of the actuating element are possible. If the blocking body of the adjusting device is released, the spring receptacle ring can be moved on the outer tube. In the release position, the spring receptacle ring can be moved upwards and downwards along the longitudinal axis of the outer tube in the installation position. This makes it possible to adjust the position of the spring receptacle along the longitudinal axis of the vibration damper in such a way that the spring tension of a suspension spring arranged on the spring receptacle during use can be adapted to certain driving situations.

Furthermore, the spring receptacle according to the invention enables damage-free fixing of the spring receptacle ring on the outer tube of the vibration damper. To this end, the blocking body of the adjusting device lies at least partially against the spring receptacle ring in the locking position and is preloaded in the direction of a receiving region on the outer tube. This should be understood in such a way that the blocking body forms a form fit with the receiving region or is latched in the receiving region, the blocking body being supported (only) on the spring receptacle ring. The blocking body thus blocks a movement of the spring receptacle ring without being supported on the receiving region of the outer tube. This prevents the blocking body from being braced against the outer tube of the vibration damper, i.e. from exerting contact pressure on the outer tube, which often leads to damage to the vibration damper.

It is also advantageous that the adjustment of the spring receptacle ring along the longitudinal axis of the outer tube is possible in a damage-free manner. In the release position, the preload of the actuating element on the blocking body is preferably reduced to such an extent that the form fit between the blocking body and the receiving region can be released by a movement of the spring receptacle ring. This should preferably be understood in such a way that the blocking body leaves the receiving region by the movement of the spring receptacle ring. The blocking body can slide along the receiving region without causing damage to the vibration damper.

The spring receptacle ring is preferably moved along the longitudinal axis of the vibration damper manually or by means of a suitable tool. The movement is advantageously substantially force-free, i.e. possible with little expenditure of force.

A further advantage of the invention is that the latching of the blocking body in the receiving region of the outer tube is clearly perceptible and/or audible. This makes it possible to assess how the position of the spring receptacle ring along the longitudinal axis of the vibration damper has been adjusted. For example, the blocking body produces a “click” noise when it latches in the receiving region on the outer tube. The noise is advantageously achieved by the fact that the preload exerted by the actuating element on the blocking body is reduced considerably, but not completely, in the release position. Thus, even in the release position, a small force acts on the blocking body, which ensures that the blocking body produces a noise as soon as it latches in the receiving region of the outer tube.

In the context of this invention, the locking position should preferably be understood to mean a position of the actuating element in which the force exerted by the actuating element on the blocking body is at least so great that the blocking body is pressed against the spring receptacle ring and thereby forms a form fit with the receiving region of the outer tube. As a result, in the locking position, the spring receptacle ring is connected to the outer tube of the vibration damper in a substantially rotationally fixed manner.

In the context of this invention, the release position should preferably be understood to mean a position of the actuating element in which the force exerted by the actuating element on the blocking body is so low that the form fit between the blocking body and the receiving region can be cancelled by moving the spring receptacle ring. This should preferably be understood in such a way that the blocking body can also be arranged on the receiving region in the release position. The blocking body cannot prevent a movement of the spring receptacle ring in the release position when it is arranged on the receiving region. For this purpose, an action of force in the direction of the receiving region is required on the blocking body.

The adjusting device is preferably arranged in the spring receptacle ring. In other words, the adjusting device is preferably integrated in the spring receptacle ring. Preferably, the components of the adjusting device are arranged in the radial direction of the spring receptacle ring. The blocking body is preferably arranged radially at the inside in the spring receptacle ring, in order to be able to form a form fit with the receiving region. The actuating element is preferably arranged radially at the outside in the spring receptacle ring, in order to be accessible or actuatable from the outside, with the result that it is adjustable between the locking position and the release position.

The spring receptacle preferably comprises a plurality of adjusting devices, each comprising at least one blocking body and an actuating element. The adjusting devices may be distributed substantially uniformly over the circumference of the spring receptacle ring. What is advantageously achieved by providing a plurality of adjusting devices is that the noise produced by the plurality of blocking bodies when they latch in the receiving region is more clearly audible. Furthermore, the latching of a plurality of blocking bodies is preferably more perceptible compared to only one blocking body.

The spring receptacle is preferably used on a spring strut for a motor vehicle, in particular a sports car, which comprises, as a unit, a vibration damper and a suspension spring. The spring receptacle is preferably part of a coilover suspension.

The spring receptacle ring is preferably rotatable relative to the outer tube in the release position, in order to change the position of the spring receptacle ring along the longitudinal axis of the vibration damper. If the spring receptacle ring is released, the spring receptacle ring in the installation position is movable upwards and downwards by a rotational movement about the longitudinal axis of the outer tube along the same longitudinal axis. This ensures that the spring tension of a suspension spring arranged on the spring receptacle during use is optimally adapted to a certain driving situation.

Furthermore, the spring receptacle ring can be brought in stepwise fashion into different rotational positions about the longitudinal axis of the outer tube in the release position. As a result, the position of the spring receptacle ring along the longitudinal axis of the vibration damper is advantageously variable in stepwise fashion in dependence on the rotational position. There are various rotational positions of the spring receptacle ring along the longitudinal axis of the vibration damper. The rotational positions are preferably defined by the at least one receiving region on the outer tube of the vibration damper. If the spring receptacle ring is rotated in the release position, the blocking body leaves the receiving region. The spring receptacle ring is then further rotated until the desired position of the spring receptacle ring is reached and the blocking body in turn forms a form fit with the receiving region or a further receiving region in the circumferential direction of the outer tube.

Preferably, the outer tube of the vibration damper comprises an external thread and the spring receptacle ring comprises an internal thread. When assembled with the vibration damper, the internal thread of the spring receptacle ring engages in the external thread of the outer tube. As a result, the position of the spring receptacle ring along the longitudinal axis of the vibration damper is variable in a simple manner by a screwing movement. The screwing is manual and substantially force-free, i.e. possible with little expenditure of effort.

The length of the external thread along the longitudinal axis of the outer tube advantageously defines the region in which the position of the spring receptacle ring is adjustable. In other words, the length of the external thread determines the adjustment region for the spring receptacle ring. In this way, a large part of the length of the outer tube can be used to adjust the spring receptacle ring. This achieves a wide range of application for the spring receptacle.

Furthermore, the thread pitch of the external thread of the outer tube and of the internal thread of the spring receptacle ring makes it possible to adjust in a simple manner the position change which the spring receptacle ring experiences when the spring receptacle ring is rotated. In the case of a large or steep thread pitch, the position change or the travelled height difference for the spring receptacle ring is greater than in the case of a low or flat thread pitch.

The at least one receiving region for the blocking body may be in the form of a groove which preferably extends in the longitudinal direction of the outer tube. The groove may be formed in the external thread of the outer tube. In this case, the groove at least partially interrupts the external thread. The groove may form an elongate depression in the outer tube or external thread of the outer tube. The groove preferably extends in the longitudinal direction of the outer tube, preferably over the entire adjustment region. What is achieved by the groove is that the latching of the blocking body is perceptible and/or audible, with the result that the number of rotational positions though which the spring receptacle ring has been adjusted can be easily assessed. This is particularly advantageous if during use on a motor vehicle the view of the spring receptacle is blocked by a wheel or other parts of the vehicle, since a rotational position and thus longitudinal position of the spring receptacle during or after adjustment is conceivable due to the haptic or audible feedback.

Furthermore, the outer tube may comprise a plurality of receiving regions, in particular grooves, for the blocking body which are spaced apart from each other in the circumferential direction of the outer tube. This should preferably be understood in such a way that a plurality of grooves can be formed in the external thread of the outer tube, each of which extend in the longitudinal direction of the vibration damper preferably over the entire adjustment region. The plurality of receiving regions are preferably spaced apart from each other substantially uniformly in the circumferential direction of the outer tube. For example, six receiving regions may be provided, which are spaced from each other in the circumferential direction of the outer tube in each case by an angle of 60°. In any case, it is advantageous if the receiving regions are distributed uniformly in the circumferential direction. A different number of receiving regions is possible.

Providing a plurality of receiving regions makes it possible to increase the number of possible rotational positions. This reduces the height difference from one rotational position to the next. If only one adjusting device is provided and only one receiving region is arranged on the outer tube, a full revolution of the spring receptacle ring through 360° is necessary to change from one rotational position to the subsequent one. If, for example, four receiving regions are provided, a rotation of the spring receptacle ring through 90° is necessary to change from one rotational position to the next.

In a preferred embodiment, the spring receptacle ring comprises at least one bore for receiving the adjusting device, said bore extending in the radial direction of the spring receptacle ring. The adjusting device can thus be easily integrated in the spring receptacle ring. The blocking body is preferably arranged radially at the inside in the bore, in order to be able to form a form fit with the receiving region. The actuating element is preferably arranged radially at the outside in the bore, in order to be actuatable from the outside.

The bore may comprise an internal thread and the actuating element may comprise an external thread, with the result that the actuating element can be screwed with the bore. In this way, the blocking body can be easily preloaded by the actuating element in the direction of the receiving region. By screwing the actuating element in the radial direction of the spring receptacle ring inwards, i.e. in the direction of the blocking body, the locking position is reached in which the blocking body is supported on the spring receptacle ring and thus prevents a movement of the spring receptacle ring on the outer tube. By screwing the actuating element in the radial direction of the spring receptacle ring outwards, i.e. away from the blocking body, the release position is reached and thus enables a movement of the spring receptacle ring on the outer tube.

Particularly preferably, the bore comprises at least one shoulder on which the blocking body is supported in the locking position. If the blocking body in the locking position forms a form fit with the receiving region or latches in the receiving region, the blocking body is advantageously supported only on the shoulder of the bore. The shoulder thus prevents the blocking body from being supported on the receiving region of the outer tube. This prevents the blocking body from being braced against the outer tube of the vibration damper, which would lead to damage to the vibration damper.

In the installed state, a clamping element, in particular a spring, may be arranged between the blocking body and the actuating element, said clamping element applying a clamping force in the direction of the outer tube. This should preferably be understood in such a way that the actuating element compresses or preloads the clamping element and the clamping element is thereby advantageously pressed against the blocking body. The clamping element thus transmits the force from the actuating element to the blocking body. What is achieved in a simple manner by the clamping element is that the blocking body can also form a form fit with the receiving region in the release position. This should preferably be understood in such a way that the clamping element applies a residual preload force to the blocking body in the release position. The residual preload force is so low that the form fit between the blocking body and the receiving region can be cancelled by moving the spring receptacle ring. The residual preload force of the clamping element advantageously ensures that, when changing from one rotational position to the next, the blocking body is pressed into the receiving region on the outer tube and thus produces a noise. This makes it easy to determine the number of rotational positions through which the spring receptacle ring has been moved.

Preferably, the blocking body is of substantially spherical form. In other words, the blocking body has substantially the shape of a sphere. Other configurations of the blocking body are possible. What is achieved by the spherical shape of the blocking body is that, when the spring receptacle ring is being moved or rotated, the blocking body in the release position can easily slide out of the receiving region and then easily slide into the receiving region again. This ensures an adjustment of the spring receptacle that is reduced in force as much as possible.

Furthermore, in the installed state, a securing element may be arranged on the spring receptacle ring in such a way that it forms a stop for the actuating element in the radial direction. The securing element is preferably arranged radially at the outside in the bore of the spring receptacle ring. Preferably, the securing element is arranged transversely to the longitudinal axis of the bore. The securing element is advantageously used such that the actuating element, when moving from the locking position into the release position, remains in the spring receptacle ring or in the bore of the spring receptacle ring. The securing element thus serves as a safeguard against the actuating element falling out. The securing element may, for example, be a pin. Other configurations of the securing element are possible.

In some embodiments, the invention relates to a vibration damper, in particular a spring strut, for a motor vehicle comprising at least one spring receptacle according to the invention. In this respect, reference is made to the advantages explained in connection with the spring receptacle. Moreover, the vibration damper may alternatively or additionally have individual features or a combination of a plurality of features mentioned above in relation to the spring receptacle.

In some embodiments, the invention relates to a method for adjusting the position of a spring receptacle along the longitudinal axis of the vibration damper. First, the actuating element of the adjusting device, said actuating element preloading the blocking body in the direction of a receiving region of the outer tube, is moved from at least one locking position into at least one release position, in order to release the spring receptacle ring. The force exerted by the actuating element on the blocking body is advantageously reduced to such an extent that the spring receptacle ring is movable on the outer tube. Then, the spring receptacle ring is moved relative to the outer tube of the vibration damper, in order to change the position of the spring receptacle ring along the longitudinal axis of the vibration damper. As a result of the movement of the spring receptacle ring, the blocking body advantageously leaves the receiving region on the outer tube. The spring receptacle ring is preferably moved until the desired position of the spring receptacle ring is reached and the blocking body in turn is arranged on the receiving region of the outer tube. Preferably, the spring receptacle ring is rotated relative to the outer tube, in order to change the position of the spring receptacle ring. Lastly, the actuating element is moved from the release position into the locking position, wherein the blocking body lies at least partially against the spring receptacle ring in the locking position in such a way that a form fit is formed between the blocking body and the receiving region in the circumferential direction of the outer tube. The force exerted by the actuating element on the blocking body is advantageously increased to such an extent that, in the locking position, the spring receptacle ring is connected to the outer tube of the vibration damper in a substantially rotationally fixed manner.

With regard to the method, reference is made to the advantages explained in connection with the spring receptacle. Moreover, the method may alternatively or additionally have individual features or a combination of a plurality of features mentioned above in relation to the spring receptacle.

The invention is explained in more detail below with further details with reference to the appended drawings. The illustrated embodiments illustrate examples of how the apparatus according to the invention and the vibration damper according to the invention can be configured.

Below, the same reference numerals are used for identical or identically acting parts.

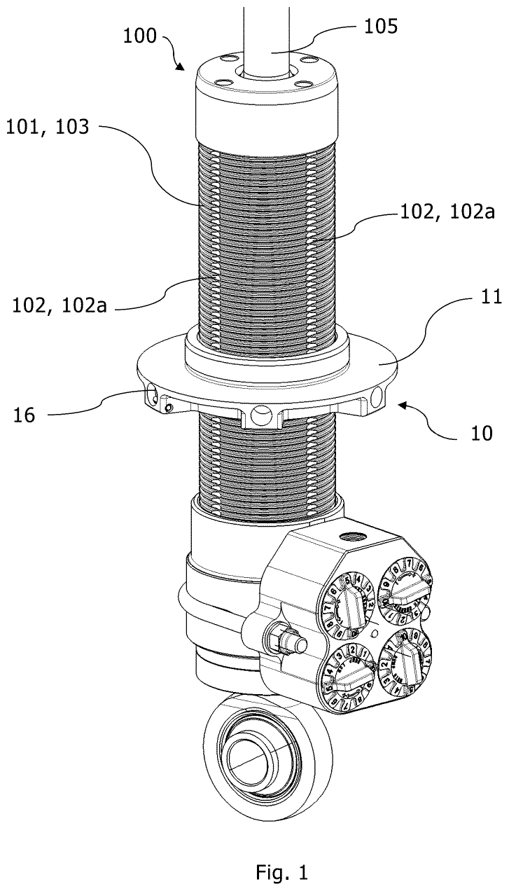

FIG. 1 shows a spring receptacle 10, in particular a spring plate, for a vibration damper 100. This is the application of the spring receptacle 10 to receive a suspension spring, such as a helical spring (not illustrated). The spring receptacle 10 ensures during use that the suspension springs are kept under tension, in order to optimally absorb shocks caused by an uneven roadway.

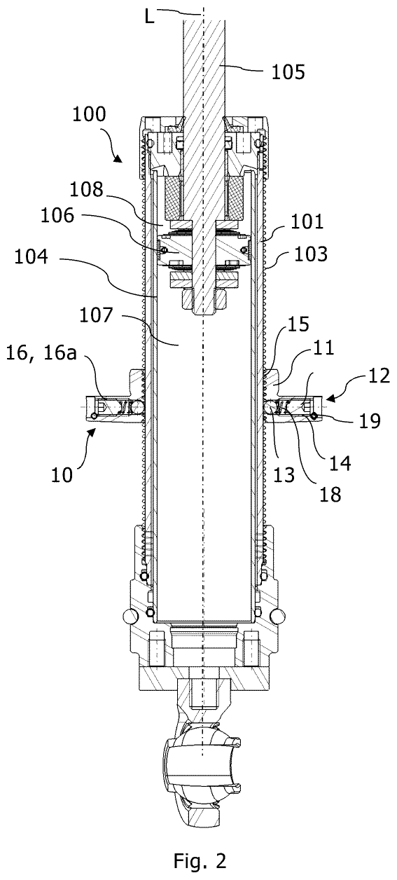

The spring receptacle 10 comprises a spring receptacle ring 11. In the installed state, the spring receptacle ring 11 is arranged on an outer tube 101 of the vibration damper 100 (see FIGS. 1 and 2). The spring receptacle ring 11 has a contact region or a contact surface on which the suspension spring rests during use (not illustrated).

Furthermore, the spring receptacle 10 comprises a plurality of adjusting devices 12 which are designed to change or fix the position of the spring receptacle ring 11 along the longitudinal axis L of the vibration damper 100. The adjusting devices 12 can block or release a movement of the spring receptacle ring 11 on the outer tube 101 of the vibration damper 100.

It is clearly apparent from FIG. 1 that the plurality of adjusting devices 12 are arranged substantially uniformly in the circumferential direction of the spring receptacle 10 or the spring receptacle ring 11.

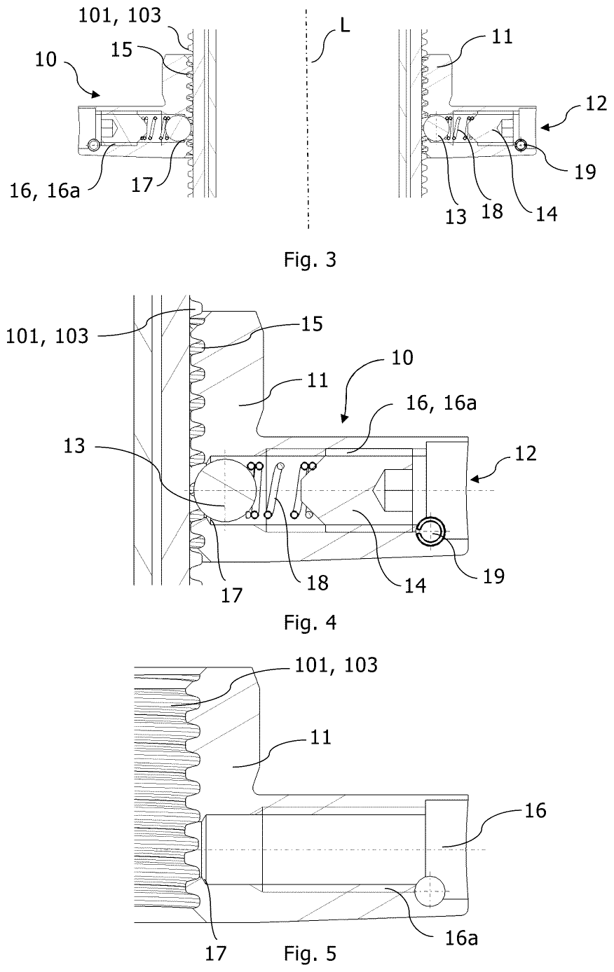

FIG. 3 illustrates the spring receptacle 10 in a longitudinal section. FIG. 4 shows an enlarged detail of the spring receptacle 10 according to FIG. 3. It can be seen in FIGS. 3 and 4 that the adjusting devices 12 each comprise a blocking body 13. The blocking bodies 13 are designed to fix the spring receptacle ring 11 on the outer tube 101. Furthermore, the blocking bodies 13 are adapted to release a movement of the spring receptacle ring 11 on the outer tube 101.

Furthermore, the adjusting devices 12 each comprise an actuating element 14, which is designed to block or release the blocking body 13. An action of force on the actuating elements 14 is transferred to the corresponding blocking bodies 13, with the result that the spring receptacle ring 11 is fixed on the outer tube 101 or released. Specifically, the actuating elements 14 are in the form of grub screws.

The actuating element 14 of an adjusting device 12 is movable in such a way that the blocking body 13 is movable between at least one locking position and a release position. In the release position, the spring receptacle ring 11 is movable on the outer tube 101. In the locking position, the spring receptacle ring 11 is arranged on the outer tube 101 in a rotationally fixed manner. FIGS. 3 and 4 show the spring receptacle 10 in the locking position.

Furthermore, the blocking body 13 of an adjusting device 12 is preloadable or preloaded by the actuating element 14 in the direction of a receiving region 102 of the outer tube 101. In the locking position, the blocking body 13 is preloaded by the actuating element 14 in such a way that the spring receptacle ring 11 is fixed on the outer tube 101. In the release position, the blocking body 13 is preloaded by the actuating element 14 in such a way that the spring receptacle ring 11 is movable on the outer tube 101.

In the locking position, the blocking body 13 lies at least partially against the spring receptacle ring 11 in such a way that a form fit is formed between the blocking body 13 and the receiving region 102 in the circumferential direction of the outer tube 101. The blocking body 13 consequently forms a form fit with the receiving region 102 without being supported on the receiving region 102. Rather, the blocking body 13 is supported only on the spring receptacle ring 11. This prevents the blocking body 13 from being braced against the outer tube 101 of the vibration damper 100, which would lead to damage to the vibration damper 100.

In the locking position, the blocking body 13 latches in the receiving region 102. The latching is clearly perceptible and/or audible. The noise or the perceptible latching is achieved by the fact that the preload exerted by the actuating element 14 on the blocking body 13 is not completely reduced in the release position. Thus, even in the release position, a small force acts on the blocking body 13, which ensures that the blocking body 13 springs into the receiving region 102 as soon as it faces the receiving region 102 during the movement of the spring receptacle ring 11. The noise or the perceptible latching allows a user to assess how the position of the spring receptacle ring 11 along the longitudinal axis L of the vibration damper 100 has been adjusted.

The spring receptacle ring 11 is rotatable relative to the outer tube 101 in the release position. The position of the spring receptacle ring 11 along the longitudinal axis L of the vibration damper 100 is variable by rotation. The spring receptacle ring 11 is movable upwards and downwards by rotation in the installation position. The rotation of the spring receptacle ring 11 is effected manually or by means of a suitable tool and is possible substantially in a force-free manner.

In the release position, the spring receptacle ring 11 can be brought in stepwise fashion into different rotational positions. As a result, the position of the spring receptacle ring 11 along the longitudinal axis L of the vibration damper 100 is variable in stepwise fashion in dependence on the rotational position.

The different rotational positions are defined by the receiving region 102 on the outer tube 101 of the vibration damper 100. If the spring receptacle ring 11 is rotated in the release position, the blocking body 13 leaves the receiving region 102. The spring receptacle ring 11 is then further rotated until the desired position of the spring receptacle ring 11 is reached and the blocking body 13 in turn forms a form fit with the receiving region 102 in the circumferential direction of the outer tube 101.

FIGS. 3 and 4 show that the outer tube 101 of the vibration damper 100 comprises an external thread 103 and the spring receptacle ring 11 comprises an internal thread 15. The internal thread 15 of the spring receptacle ring 11 engages in the external thread 103 of the outer tube 101. The position of the spring receptacle ring 11 along the longitudinal axis L of the vibration damper 100 is variable by screwing.

The length of the external thread 103 along the longitudinal axis L of the outer tube 101 defines the adjustment region for the spring receptacle ring 11, i.e. the region in which the position of the spring receptacle ring 11 is adjustable.

The receiving region 102 for the blocking body 13 is in the form of a groove 102a which extends in the longitudinal direction L of the outer tube 101. It can be seen that the groove 102a forms an elongate depression in the outer tube 101 or in the external thread 103 of the outer tube 101. The receiving region 102 or the groove 102a is of substantially concave form. The groove 102a extends in the longitudinal direction L of the outer tube 101 over the entire adjustment region.

FIG. 1 shows that the outer tube 101 comprises a plurality of receiving regions 102 or grooves 102a which are spaced apart from each other in the circumferential direction of the outer tube 101. It can be seen that the outer tube 101 comprises four receiving regions 102 which are spaced apart from each other in the circumferential direction of the outer tube 101 in each case by an angle of 90°.

FIG. 1 shows that the spring receptacle ring 11 comprises a plurality of bores 16 for receiving a respective adjusting device 12. FIG. 5 illustrates one of the bores 16 of the spring receptacle ring 11, without an adjusting device 12.

The bore 16 extends in the radial direction of the spring receptacle ring 11. When assembled with the vibration damper 100, the bore 16 extends orthogonally or transversely to the longitudinal axis L of the vibration damper 100.

FIG. 4 illustrates that the bore 16 comprises an internal thread 16a and the actuating element 14 comprises an external thread, with the result that the actuating element 14 can be screwed with the bore 16. By screwing the actuating element 14 in the radial direction of the spring receptacle ring 11 inwards, i.e. in the direction of the blocking body 13, the locking position is reached. By screwing the actuating element 14 in the radial direction of the spring receptacle ring 11 outwards, i.e. away from the blocking body 13, the release position is reached.

FIGS. 4 and 5 also show that the bore 16 of the spring receptacle ring 11 comprises a shoulder 17 on which the blocking body 13 is supported in the locking position. In the locking position, the blocking body 13 forms a form fit with the receiving region 102 in such a way that the blocking body 13 latches in the receiving region 102, but is supported only on the shoulder 17 of the bore 16.

FIGS. 3, 4 and 7 show that a clamping element 18 or a spring is arranged between the blocking body 13 and the actuating element 14, said clamping element applying a clamping force in the direction of the outer tube 101. The clamping element 18 transmits a force applied to the actuating element 14 to the blocking body 13. The blocking body 13 is thereby preloaded in the direction of the outer tube 101.

By way of the clamping element 18, a force acts on the blocking body 13 even in the release position. This force is so low that the form fit between the blocking body 13 and the receiving region 102 can be cancelled by moving the spring receptacle ring 11. If in the release position the blocking body 13 is arranged in the receiving region 102 and then the spring receptacle ring 11 is rotated, the blocking body 13 is moved counter to the force of the clamping element 18 out of the receiving region 102. If the spring receptacle ring 11 is further rotated until the blocking body 13 again faces the receiving region 102, the blocking body 13 is pressed into the receiving region 102 by the force of the clamping element 18.

FIGS. 2, 3, 4 and 7 show that the blocking body 13 is of substantially spherical form. As a result, in the release position, when the spring receptacle ring 11 is being rotated, the blocking body 13 slides easily out of the receiving region 102 or into the receiving region 102. To this end, the receiving region 102 and the groove 102a are designed to substantially correspond to the spherical shape of the blocking body 13, i.e. to be of substantially concave form.

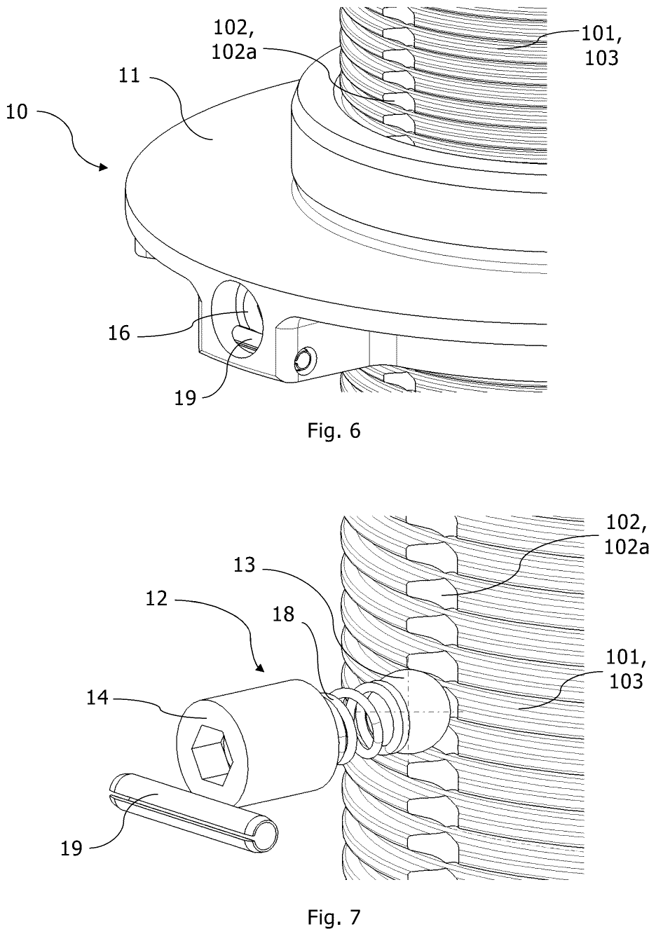

FIGS. 3, 4, 6 and 7 illustrate that a securing element 19 is arranged on the spring receptacle ring 11 in such a way that it forms a stop for the actuating element 14 in the radial direction. The securing element 19 is arranged radially at the outside in the bore 16 of the spring receptacle ring 11 and transversely to the longitudinal axis of the bore 16. The securing element 19 forms a stop for the actuating element 14 in such a way that the actuating element 14, when moving from the locking position into the release position, remains in the spring receptacle ring 11 or in the bore 16 of the spring receptacle ring 11.

FIG. 1 shows by way of example a vibration damper 100 on which the spring receptacle 10 is used. This is the application of the vibration damper 100 for a motorized vehicle. Specifically, the vibration damper 100 is used for motorsports vehicles, in particular for racing cars or sports cars. Other applications are possible.

The vibration damper 100 according to FIG. 1 is a twin-tube vibration damper. The vibration damper 100 comprises an outer tube 101 and an inner tube 104. The inner tube 104 is arranged coaxially with the outer tube 101 and forms an annular gap with the outer tube 101.

The inner tube 104 is filled with a damper fluid. The damper fluid may be a liquid or a gas. Hydraulic oil is preferably used as the damper fluid.

The vibration damper 100 is shown in longitudinal section in FIG. 2. It can be seen that the vibration damper 100 comprises a working piston 106 arranged on a piston rod 105. The piston rod 105 is fixedly arranged on the working piston 106. The working piston 106 is guided in the inner tube 104 or is axially movable in the inner tube 104. The working piston 106 divides the interior of the inner tube 104 into a first and a second working chamber 107, 108.

The first working chamber 107 is remote from the piston rod and the second working chamber 108 is on the piston rod side. The first working chamber 107 is formed between the working piston 106 and a longitudinal end of the vibration damper 100 that is remote from the piston rod. The second working chamber 108 is formed between the working piston 106 and a piston-rod-side longitudinal end of the vibration damper 100.

The method for adjusting the position of the spring receptacle 10 along the longitudinal axis L of the vibration damper 100 is explained in more detail on the basis of FIG. 2. First, the spring receptacle 10 comprising the spring receptacle ring 11 and the adjusting device 12 is arranged on the outer tube 101 of the vibration damper 100. In this case, the actuating element 14 of the adjusting device 12 is in the starting position in the locking position, as a result of which the spring receptacle ring 11 is connected to the outer tube 101 in a rotationally fixed manner. In order to change the position of the spring receptacle ring 11 along the longitudinal axis L of the outer tube 101, the actuating element 14 of the adjusting device 12 is moved from the locking position into the release position, i.e. in the radial direction of the spring receptacle ring 11 outwards. This reduces the force exerted by the actuating element 14 via the clamping element 18 on the blocking body 13 and the spring receptacle ring 11 is released. Then, the spring receptacle ring 11 is rotated relative to the outer tube 101, in order to change its position along the longitudinal axis L of the vibration damper 100. Here, the blocking body 13 is moved counter to the force of the clamping element 18 out of the receiving region 102 of the outer tube 101. The rotation of the spring receptacle ring 11 is continued until the desired position is reached. Here, the blocking body 13 faces the receiving region 102 and latches in the receiving region 102 several times. This produces a noise that allows a user to determine the extent to which the spring receptacle ring 11 has been adjusted. If the spring receptacle ring 11 is in the desired position, the actuating element 14 is moved from the release position into the locking position, wherein the blocking body 13 lies against the spring receptacle ring 11, or is pressed against the shoulder 17 in the bore 16 of the spring receptacle ring 11, in such a way that a form fit is formed between the blocking body 13 and the receiving region 102 in the circumferential direction of the outer tube 101. As a result, the spring receptacle ring 11 is connected to the outer tube 101 in a rotationally fixed manner.

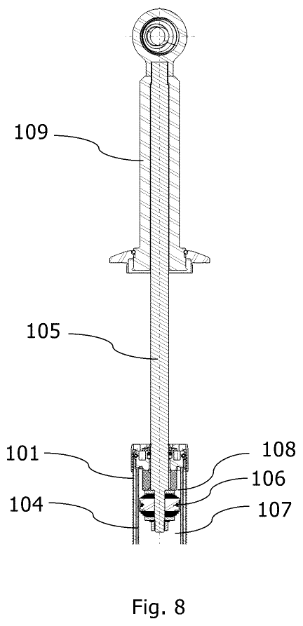

FIG. 8 shows a vibration damper 100 according to a non-inventive exemplary embodiment. Owing to the installation space present in a vehicle, it may be necessary for a vibration damper 100 to comprise an extension element 109 which is arranged on the piston rod 105 and serves as a force-transmitting connection to the body of the vehicle. If the piston rod 105 is extended in the rebound stage and then experiences high piston rod speed in the bump stage, this can lead to a high action of force on the piston rod 105 and thus to damage to the vibration damper 100.

To connect the piston rod 105 to the extension element 109, the piston rod 105 comprises an external thread at its upper (in the installation position) end, said external thread being able to be screwed with a corresponding internal thread of the extension element 109. The diameter of the piston rod 105 is smaller in the region of the external thread than in the remaining region of the piston rod 105. As a result, the region of the piston rod 105 that comprises the external thread is susceptible, particularly under high action of force, to damage, such as bending, kinking and/or breaks.

According to FIG. 8, it is provided that the piston rod 105 extends virtually over the entire length of the extension element 109. To this end, the extension element 109 comprises a cylindrical cavity for receiving the piston rod 105. In FIG. 8, the screw connection between the piston rod 105 and the extension element 109 is arranged at the upper (in the installation position) end of the extension element 109. As a result, the external thread of the piston rod 105 is arranged on a region of the vibration damper 100 that is subjected to a low load during use.

Damage to the piston rod 105 or the vibration damper 100 can thus be avoided.

### LIST OF REFERENCE SIGNS

10 Spring receptacle
11 Spring receptacle ring
12 Adjusting device
13 Blocking body
14 Actuating element
15 Internal thread of the spring receptacle ring
16 Bore
16a Internal thread of the bore
17 Shoulder
18 Clamping element
19 Securing element
100 Vibration damper
101 Outer tube
102 Receiving region
102a Groove
103 External thread of the outer tube
104 Inner tube
105 Piston rod
106 Working piston
107 First working chamber
108 Second working chamber
109 Extension element
L Longitudinal axis of the vibration damper

1. A spring receptacle for a vibration damper, comprising:
at least one spring receptacle ring, which in the installed state is arranged on an outer tube of the vibration damper; and
at least one adjusting device, which is designed to change or fix the position of the spring receptacle ring along the longitudinal axis of the vibration damper;
wherein the adjusting device comprises at least one blocking body and at least one actuating element which preloads the blocking body in the direction of a receiving region of the outer tube and is movable between at least one locking position and at least one release position;
wherein the blocking body lies at least partially against the spring receptacle ring in the locking position in such a way that a form fit is formed between the blocking body and the receiving region in the circumferential direction of the outer tube.

2. The spring receptacle according to claim 1, wherein the spring receptacle ring is rotatable relative to the outer tube in the release position, in order to change the position of the spring receptacle ring along the longitudinal axis of the vibration damper.

3. The spring receptacle according to claim 1, wherein the spring receptacle ring can be brought in stepwise fashion into different rotational positions in the release position, with the result that the position of the spring receptacle ring along the longitudinal axis of the vibration damper is variable in stepwise fashion in dependence on the rotational position.

4. The spring receptacle according to claim 1, wherein the outer tube of the vibration damper comprises an external thread and the spring receptacle ring comprises an internal thread, with the result that the position of the spring receptacle ring along the longitudinal axis of the vibration damper is variable by screwing.

5. The spring receptacle according to claim 1, wherein the at least one receiving region for the blocking body is in the form of a groove which preferably extends in the longitudinal direction of the outer tube.

6. The spring receptacle according to claim 1, wherein the outer tube comprises a plurality of receiving regions for the blocking body which are spaced apart from each other in the circumferential direction of the outer tube.

7. The spring receptacle according to claim 1, wherein the outer tube comprises a plurality of grooves for the blocking body which are spaced apart from each other in the circumferential direction of the outer tube.

8. The spring receptacle according to claim 1, wherein the spring receptacle ring comprises at least one bore for receiving the adjusting device, said bore extending in the radial direction of the spring receptacle ring.

9. The spring receptacle according to claim 1, wherein the bore comprises an internal thread and the actuating element comprises an external thread, with the result that the actuating element can be screwed with the bore.

10. The spring receptacle according to claim 1, wherein the bore comprises at least one shoulder on which the blocking body is supported in the locking position.

11. The spring receptacle according to claim 1, wherein in the installed state, a clamping element is arranged between the blocking body and the actuating element, said clamping element applying a clamping force in the direction of the outer tube.

12. The spring receptacle according to claim 1, wherein in the installed state, a clamping element including a spring is arranged between the blocking body and the actuating element, said clamping element applying a clamping force in the direction of the outer tube.

13. The spring receptacle according to claim 1, wherein the blocking body is of substantially spherical form.

14. The spring receptacle according to claim 1, wherein in the installed state, a securing element is arranged on the spring receptacle ring in such a way that it forms a stop for the actuating element in the radial direction.

15. The spring receptacle according to claim 1, wherein the spring receptacle is a spring plate.

16. A vibration damper for a motor vehicle comprising at least one spring receptacle according to claim 1.

17. The vibration damper according to claim 16, wherein the vibration damper is a spring strut.

18. A method for adjusting the position of a spring receptacle, along the longitudinal axis of a vibration damper, wherein the spring receptacle comprises at least one spring receptacle ring, which in the installed state is arranged on an outer tube of the vibration damper, and at least one adjusting device, wherein the method comprises:
moving an actuating element of the adjusting device, said actuating element preloading the blocking body in the direction of a receiving region of the outer tube, from at least one locking position into at least one release position, in order to release the spring receptacle ring;
moving the spring receptacle ring relative to the outer tube of the vibration damper, in order to change the position of the spring receptacle ring along the longitudinal axis of the vibration damper; and
moving the actuating element from the release position into the locking position, wherein the blocking body lies at least partially against the spring receptacle ring in the locking position in such a way that a form fit is formed between the blocking body and the receiving region in the circumferential direction of the outer tube.
